(19) United States
(12) Patent Application Publication
(10) Pub. No.: US 2008/0066289 A1
(43) Pub. Date: Mar. 20, 2008

(54) Through-hole stamping method in bracket made of bent plate

(75) Inventor: Yasutoshi Gokan, Tokyo (JP)

Correspondence Address: RABIN & Berdo, PC, 1101 14TH STREET, NW, SUITE 500, WASHINGTON, DC, 20005, US

(73) Assignee: KAYABA INDUSTRY CO., LTD., Tokyo (JP)

(21) Appl. No.: 11/518,897

(22) Filed: Sep. 12, 2006

(51) Int. Cl. B23P 11/00; B23P 17/00

(52) U.S. Cl. 29/505; 29/525.14

(57) ABSTRACT

A manufacturing method is proposed for a bracket which is formed by bending a flat plate (11) into a predetermined shape including a pair of flat parts (4, 5a) disposed in parallel with each other. The pair of flat parts (4, 5a) has a through-hole (6, 6a, 6b) for inserting a bolt. The method comprises forming a weak portion (12, 14) in advance in the flat plate (11) in positions corresponding to a through-hole (6, 6a, 6b). The weak portion (12, 14) is a portion which is structurally weaker than an adjacent portion of the plate (11). The method further comprises bending the flat plate (11) into the predetermined shape, and forming the through-holes (6, 6a, 6b) by stamping out the weak portion (12, 14). By forming the weak portion (12, 14) in advance, the stamping force required for forming the through-hole (6, 6a, 6b) is reduced.

### FIELD OF THE INVENTION

This invention relates to a manufacturing method for a bracket made of a bent plate such as a knuckle bracket used for fixing a hydraulic damper to a knuckle arm of the wheel axis of an automobile or industrial vehicle.

### BACKGROUND OF THE INVENTION

When an automobile or industrial vehicle is running, vibration occurs as a result of shock exerted on a suspension spring. A strut type hydraulic shock absorber is a device for promptly absorbing such vibration. The hydraulic shock absorber is interposed between a vehicle body and a wheel axis. The hydraulic shock absorber functions not only to absorb vibration when the vehicle is running, but also to position the wheel axis, and hence the hydraulic shock absorber requires sufficient rigidity.

JP2002-295569A, published by Japan Patent Office in 2002, teaches a knuckle bracket which is used for fixing a hydraulic shock absorber to the wheel axis of a vehicle.

The knuckle bracket comprises a cylindrical part which encircles an outer shell of the shock absorber and a pair of flat parts extending laterally from both ends of the cylindrical part. The knuckle bracket is formed by bending a rectangular plate.

The upper end and the lower end of the cylindrical part are fixed to the outer shell by welding. An inner bracket is interposed between the pair of flat parts. The inner bracket is a plate formed into a channel-shaped cross section and has a pair of flat parts which are respectively welded onto the pair of flat parts of the knuckle bracket.

The knuckle bracket is fixed to a knuckle arm fixed to the wheel axis via a plurality of bolts which penetrate the pair of flat parts of the knuckle bracket and the pair of flat parts of the inner bracket.

### SUMMARY OF THE INVENTION

For this purpose, through-holes are formed in advance in the pair of flat parts of the knuckle bracket and in the pair of flat parts of the inner bracket such that the bolts can penetrate the through-holes.

These through-holes are formed for example by stamping out the flat parts of the knuckle bracket together with the flat parts of the inner bracket after these brackets are fixed to the outer shell. Considering the precision of a bending process for bending a plate into the knuckle bracket or inner bracket, and deformation of the brackets by welding, the through-holes must be formed when the brackets are fixed onto the outer shell.

However, in order to stamp out a plurality of through-holes in the small flat parts, a complicated stamping device is required.

Further, if a wall thickness of the plates constituting the knuckle bracket and the inner bracket is increased in order to increase the rigidity of the brackets, the stamping force of the stamping device must be increased to form the through-holes, and hence the driving power of the stamping device must be increased.

In this case, however, the rim of the through-holes may be deformed due to a strong stamping force when the through-holes are stamped out, and as a result the bolt may not penetrate the through-holes smoothly.

It is therefore an object of this invention to enable through-holes to be stamped into a bracket made of a bent plate with a constant stamping force, irrespective of the thickness of the plate.

In order to achieve the above object, this invention provides a manufacturing method for a bracket which is formed by bending a flat plate into a predetermined shape including a pair of flat parts disposed in parallel with each other. The pair of flat parts has a through-hole for inserting a bolt. The method comprises forming a weak portion in the flat plate in advance in a position corresponding to the through-hole. Herein, the weak portion is a portion which is structurally weaker than an adjacent portion of the flat plate. The method further comprises bending the flat plate into the predetermined shape, and forming the through-hole by stamping out the weak portion.

The details as well as other features and advantages of this invention are set forth in the remainder of the specification and are shown in the accompanying drawings.

### BRIEF DESCRIPTION OF THE DRAWINGS

FIG. 1 is side view of a knuckle bracket manufactured by a manufacturing method according to this invention.

FIG. 2 is a cross-sectional view of the knuckle bracket taken along a line II-II in FIG. 1.

FIG. 3 is a plan view of a flat plate serving as a base material of the knuckle bracket.

FIG. 4 is a cross-sectional view of the knuckle bracket, illustrating a process of stamping out a weak portion to form a through-hole.

FIG. 5 is an enlarged cross-sectional view of a recess formed as a weak portion according to a second embodiment of this invention.

### DESCRIPTION OF THE PREFERRED EMBODIMENTS

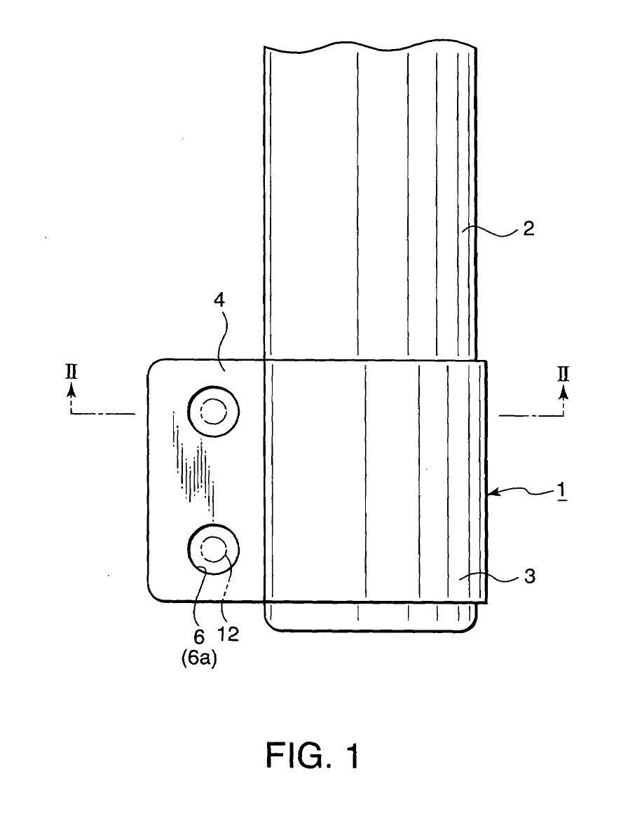

Referring to FIG. 1 of the drawings, a knuckle bracket for fixing an outer shell 2 of a shock absorber onto a wheel axis of a vehicle comprises an outer bracket 1.

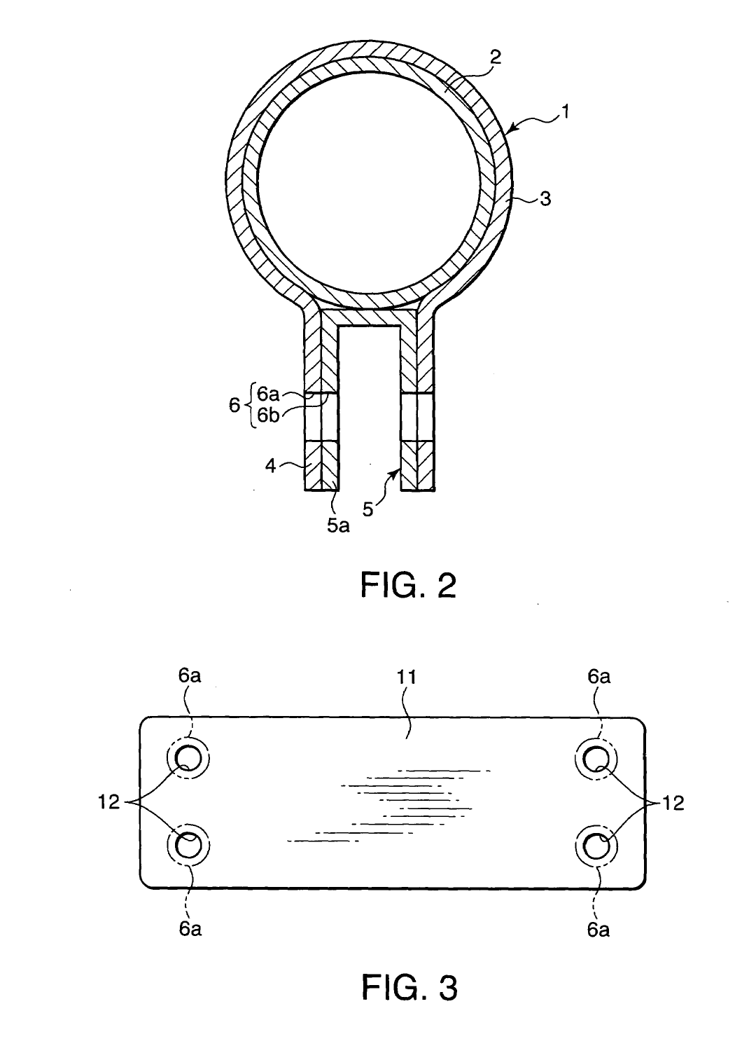

Referring to FIG. 2, the outer bracket 1 comprises a cylindrical part 3 which encircles the outer shell 2 so as to hold the outer shell 2, and a pair of flat parts 4 which laterally project from both ends of the cylindrical part 3 in parallel with each other.

The cylindrical part 3 is fixed to the outer shell 2 by welding upper and lower rims of the cylindrical part 3 onto the outer circumference of the outer shell 2.

The shock absorber constitutes a part of a suspension device for a vehicle. The outer bracket 1 is constructed by bending a flat plate 1 1 into a rectangular shape shown in FIG. 3.

Referring again to FIG. 2, the knuckle bracket further comprises an inner bracket 5 having a channel-shaped cross section. The inner bracket 5 is also constructed by bending a flat plate and has a pair of flat parts 5a. The inner bracket 5 is interposed between the pair of flat parts 4 of the outer bracket 1 such that the pair of flat parts 5a of the inner bracket 5 respectively overlaps the pair of flat parts 4 of the outer bracket 1. The pair of flat parts 5a is then fixed to the pair of flat parts 4 by projection welding.

Two through-holes 6 for passing bolts are formed in the pair of flat parts 4 of the outer bracket 1 and in the pair of flat parts 5a of the inner bracket 5 respectively.

A knuckle arm fixed to the wheel axis is inserted into the inner bracket 5. Two bolts are inserted into the through-holes 6 and corresponding through-holes formed in the knuckle arm, and secured by nuts.

Next, the method of forming the through-holes 6 will be described.

As described above, both the outer bracket 1 and the inner bracket 5 are constructed by bending plates. Since the precision of the bending process generally does not assure the concentricity of the through-holes 6 in the flat parts 4 or 5a when the plates are bent into brackets, it is difficult to form the through-holes 6 before the bending process of the plates.

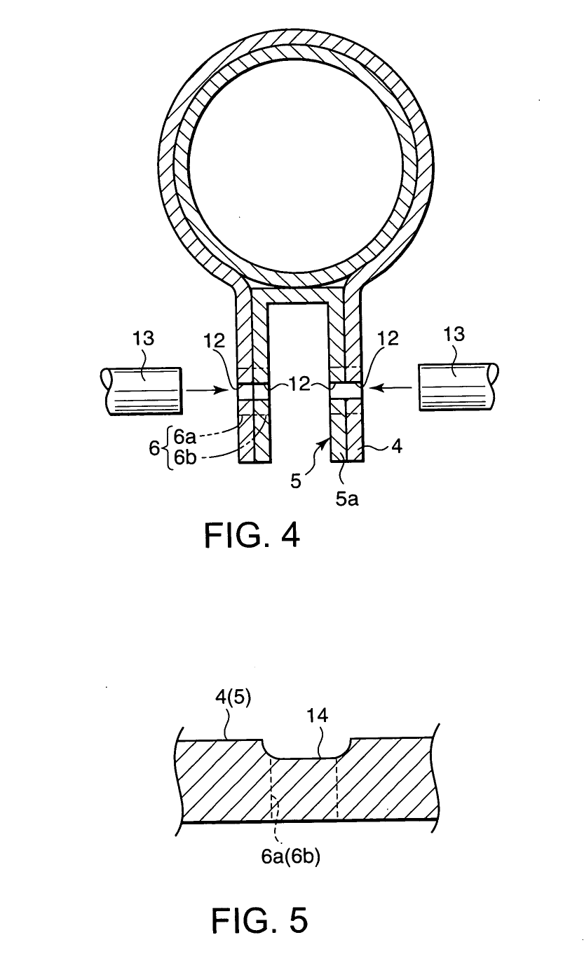

Referring to FIG. 4, the through-holes 6 are therefore formed by stamping out the pair of flat parts 4 of the outer bracket 1 and the pair of flat parts 5a of the inner bracket 5 from the outside of the pair of flat parts 4 using a pair of stamping jigs 13. The through-hole 6 comprises a hole 6a formed in the pair of flat parts 4 and a hole 6b formed continuously with the hole 6a in the pair of flat parts 5a of the inner bracket 5.

Referring again to FIG. 3, in order to assist formation of the through-holes 6 by the stamping jigs 13, small holes 12 are formed in advance in the pair of flat parts 4 of the outer bracket 1 and the pair of flat parts 5a of the inner bracket 5 in positions corresponding to the through-holes 6. The small holes 12 have a smaller diameter than the through-holes 6 and are formed in advance when the brackets 1 and 5 are still in the form of flat plates. The small holes 12 function to weaken the structural strength of a part of the plate in which the through-hole 6 is to be formed. By thus providing the pair of flat parts 4 of the outer bracket 1 and the pair of flat parts 5a of the inner bracket 5 with respective weak portions, the subsequent process of stamping out the through-holes 6 using the stamping jigs 13 is performed smoothly without applying a large stamping force.

To enhance the rigidity of the knuckle bracket, the thickness of the flat plate 11 and/or the thickness of the base material of the outer bracket 2 may be increased. Even in this case, by forming the small holes 12 in advance as the weak portion in the flat plate 11, it is possible to form the through-holes 6a in the pair of flat parts 4 using the same stamping jigs 13. The same is true for the pair of flat plates 5a of the inner bracket 5.

The diameter of the small holes 12 may be set arbitrarily according to the thickness of the flat plate 11, the thickness of the flat plate used for the inner bracket 5, the specifications of the stamping jig 13, etc., within a region smaller than the diameter of the through-holes 6.

In this embodiment, two through-holes 6 are formed in the upper part and lower part of the flat parts 4 and 5a. Needless to say, however, the number of the through-holes 6 may be determined arbitrarily.

It is also possible to form the small holes 12 in the pair of flat parts 4 of the outer bracket 1 alone or in the pair of flat parts 5a of the inner bracket 5 alone.

As described above, by forming the small holes 12 as weak portions in parts corresponding to the through-holes 6a and 6b before stamping out the through-holes 6a and 6b, formation of the through-holes 6a, 6b can be performed easily using the stamping jigs 13 without applying a large stamping force.

Next, referring to FIG. 5, a second embodiment of this invention will be described.

This embodiment relates to the form of the weak portion. In the first embodiment small holes 12 having a smaller diameter than the through-holes 6 are formed as the weak portion.

In this embodiment, recesses 14 are formed in advance instead of the small holes 12 in positions corresponding to the through-holes 6a in the flat plate 11 or the through-holes 6b in the flat plate used for the inner bracket 5.

As shown in the figure, the recess 14 has a greater diameter than the through-hole 6a, 6b.

According to this embodiment also, the condition of the knuckle bracket for stamping out the through-holes 6 is improved and the through-holes 6 are formed without applying a large stamping force.

Although the invention has been described above with reference to certain embodiments of the invention, the invention is not limited to the embodiments described above. Modifications and variations of the embodiments described above will occur to those skilled in the art, within the scope of the claims.

For example, instead of constituting the knuckle bracket by the outer bracket 1 and the inner bracket 5, it is possible to constitute the knuckle bracket by the outer bracket 1 alone.

The shock absorber to which the knuckle bracket is fixed may be of a double cylinder type or single cylinder type.

The recesses 14 may be formed either by a mechanical process or a chemical process.

The embodiments of this invention in which an exclusive property or privilege is claimed are defined as follows:

What is claimed is:

1. A manufacturing method for a bracket which is formed by bending a flat plate into a predetermined shape including a pair of flat parts disposed in parallel with each other, the pair of flat parts having a through-hole for inserting a bolt, the method comprising:
forming a weak portion in advance in the flat plate in a position corresponding to a through-hole, the weak portion being structurally weaker than an adjacent portion of the flat plate;
bending the flat plate into the predetermined shape; and
forming the through-hole by stamping out the weak portion.

2. The manufacturing method as defined in claim 1, wherein the weak portion is in the form of a small hole having a smaller diameter than the through-hole,

3. The manufacturing method as defined in claim 1, wherein the weak portion is in the form of a recess.

4. The manufacturing method as defined in claim 3, wherein a diameter of the recess is set to be greater than a diameter of the through-hole.

5. The manufacturing method as defined in claim 1, wherein the bracket comprises an outer bracket comprising a cylindrical part connected to the pair of flat parts so as to hold a cylindrical shell.

6. The manufacturing method as defined in claim 5, wherein the bracket further comprises an inner bracket which has a channel-shaped cross section including a pair of flat parts disposed in parallel with each other and interposed between the pair of flat parts of the outer bracket, and the weak portion is formed in the pair of flat parts of the outer bracket and the pair of flat parts of the inner bracket.

7. The manufacturing method as defined in claim 1, wherein the bracket is an inner bracket having a channel-shaped cross section including a pair of flat parts disposed in parallel with each other, and is associated with an outer bracket which comprises a pair of flat parts disposed in parallel with each other and a cylindrical part connected thereto so as to hold a cylindrical shell, the inner bracket is interposed between the pair of flat parts of the outer bracket, and the weak portion is formed in the pair of flat parts of the inner bracket.

8. The manufacturing method as defined in claim 7, further comprising fixing the pair of flat parts of the inner bracket onto the pair of flat parts of the outer bracket by projection welding before forming the through-hole by stamping out the weak portion.

9. The manufacturing method as defined in claim 1, wherein stamping out the weak portion is performed by applying a pair of stamping jigs to the weak portion on the pair of flat parts from outside.
